(19) United States
(12) Patent Application Publication
(10) Pub. No.: US 2026/0249693 A1
(43) Pub. Date: Aug. 27, 2026

(54) DISPLAY SYSTEM FOR VEHICLES

(71) Applicant: Faurecia Interieur Industrie, Nanterre (FR)

(72) Inventors: Stéphane DA CRUZ, Corbas (FR); Edouard DA SILVA, Pontoise (FR); Steve LIEM, Erangny Sur Oise (FR)

(21) Appl. No.: 19/552,547

(22) Filed: Feb. 27, 2026

(30) Foreign Application Priority Data
Feb. 27, 2025 (FR) FR 25 02000

(51) Int. Cl. B60K 35/28; B60K 35/22; B60Q 9/00; B60R 22/48; F21V 7/00; F21V 11/08; G07C 5/00; G07C 5/08; F21W 106/00

(52) U.S. Cl. CPC B60K 35/28; B60K 35/22; B60Q 9/00; B60R 22/48; F21V 7/00; F21V 11/08; G07C 5/004; G07C 5/0816; B60K 2360/167; B60K 2360/178; B60K 2360/23; B60R 2022/4816; B60R 2022/4866; F21W 2106/00

(57) ABSTRACT

The display system comprises: a display device having a display screen; a reflective device comprising: a semi-reflective blade extending along a plane of reflection and intended to reflect real images displayed by the display screen towards the passengers to generate corresponding virtual images in a second plane;a translucent film applied to the semi-reflective blade and comprising at least one information element;at least one lighting unit capable of illuminating the at least one information element. The at least one lighting unit comprises a light source for each information element, each light source being arranged along an edge of the translucent film and being configured to illuminate the corresponding information element through the thickness of the translucent film.

### BACKGROUND

The present invention relates to a display system for a vehicle comprising:

a display device comprising at least one display screen intended to be concealed from the passengers of said vehicle and being configured to display real images in a first plane;

a reflective device extending along a plane of reflection and comprising:

at least one semi-reflective blade extending along a plane of reflection and intended to reflect real images displayed by the at least one display screen towards the passengers to generate corresponding virtual images in a second plane;

at least one translucent film applied to the at least one semi-reflective blade and comprising at least one information element, the at least one translucent film extending parallel to the plane of reflection and having a thickness in a direction substantially perpendicular to the plane of reflection;

at least one lighting unit capable of illuminating the at least one information element.

Such a display system is, for example, arranged on a vehicle dashboard and is configured to display information to vehicle passengers relating to the operation of in-vehicle equipment, navigation, communications, entertainment (films, music, games, etc.) or the like.

In particular, at least one display system is intended to display information essential to driving, for example relating to the operation of essential vehicle components and/or navigation, aimed at the driver. This information needs to be displayed simply and clearly, as well as centrally, so that the vehicle driver can be informed as quickly as possible.

In order to be able to display a multitude of types of information, some state-of-the-art display systems feature a complex structure involving numerous display elements. However, such display systems are difficult to implement and occupy a lot of space.

Furthermore, the virtual images displayed to passengers are often overloaded with information, making it difficult for the driver, for example, to easily obtain information on a particular aspect of the vehicle and/or navigation. This can make it difficult to effectively draw the attention of the driver to essential driving information.

Also, the information overload in the image makes for an unsightly display.

Finally, the luminous intensity of virtual images can be limited, which is incompatible with displaying important regulatory information that must have a minimum luminous intensity in order to be easily discernible by the driver.

One aim of the invention is therefore to provide a display system for a vehicle wherein it is easier for passengers to acquire information and the display is more aesthetically pleasing, the display system being simple to manufacture and taking up little space.

To this end, the subject matter of the invention is a display system of the aforementioned type wherein the one lighting unit comprises a light source for each information element, each light source being arranged along an edge of the at least one translucent film and being configured to illuminate the corresponding information element through the thickness of the at least one translucent film.

By virtue of the invention, an impression of depth of the virtual images is generated by the reflection of the real images on the semi-reflective blade. The information elements appear virtually in front of the virtual images for the passengers of the vehicle, making them particularly prominent.

In addition, this sense of depth between information elements and virtual images enhances the aesthetics of the display.

Lastly, the manufacturing of the display system is facilitated and its size reduced, since the lighting unit is arranged at the edge of the at least one translucent film and the illumination of the information elements takes place within the thickness of the at least one film.

According to other advantageous aspects of the invention, the display system comprises one or more of the following features, taken alone or in any technically feasible combination:

the at least one semi-reflective blade comprises a substrate having a front face oriented substantially towards the at least one display screen and a rear face opposite the front face, the at least one translucent film being applied to the rear face of the substrate;

the reflective device comprises at least one rear anti-reflective film extending over the whole of the at least one translucent film, so that the at least one translucent film extends between the semi-reflective blade and the rear anti-reflective film;

the at least one translucent film comprises an information portion wherein the information elements are arranged, the semi-reflective blade comprising at least one semi-reflective treatment extending over at least part of the front face of the substrate so as to be arranged opposite at least the at least one information portion;

the at least one information element is a pictogram;

the pictogram is selected from a list comprising:

an indicator for the use of lights, such as position lights, low-beam headlights, high-beam headlights, front and/or rear fog lights, turn signals and/or hazard warning lights;

a malfunction indicator such as, for example an indicator for low oil level, worn front brake pads, ABS malfunction, power steering malfunction, airbag malfunction, ESP malfunction, bulb problem, low windshield washer fluid level, electronic component fault, engine pollution control problem, water in the fuel filter and/or low fuel level;

a hazard indicator such as, for example an indicator for handbrake applied, brake failure, airbag failure, trunk door open, low battery, abnormal engine oil pressure, engine oil overheating, abnormal coolant temperature, abnormal tire pressure, steering lock malfunction and/or seatbelt not fastened;

the at least one information element is printed and/or engraved, in particular micro-printed and/or micro-engraved or nano-printed and/or nano-engraved, on a body of the at least one translucent film;

the at least one translucent film comprises a plurality of information zones, each information zone comprising an information element, the information zones being compartmentalized, each light source being arranged opposite an information zone and being configured to illuminate only the information zone opposite to which it is arranged;

the reflective device delimits in the plane of reflection:

a reflection surface intended to reflect real images displayed by the at least one display screen; and

an information surface intended to illuminate the information elements; the reflection and information surfaces being separate and adjacent.

The invention further relates to a vehicle dashboard comprising a body and a display system as described previously, the display system being mounted on the dashboard body.

The invention will become clearer on reading the following description, given solely by way of non-limiting example, and made with reference to the drawings, wherein:

### BRIEF DESCRIPTION OF THE DRAWINGS

FIG. 1 is a simplified schematic depiction of several views corresponding to different portions of a vehicle dashboard according to the invention, the views being arranged one above the other for simplicity;

FIG. 2 is a simplified schematic depiction of a cross-sectional view of a display system of the dashboard of FIG. 1, according to the invention;

FIG. 3 is a simplified schematic depiction of a cross-sectional view of a reflective device of the display system of FIG. 2;

FIG. 4 is a simplified schematic depiction of a front view of a portion of the reflective device of FIG. 3;

FIG. 5 is a simplified schematic depiction of a front view of the display system depicted in FIG. 2 as seen by a vehicle passenger.

### DETAILED DESCRIPTION

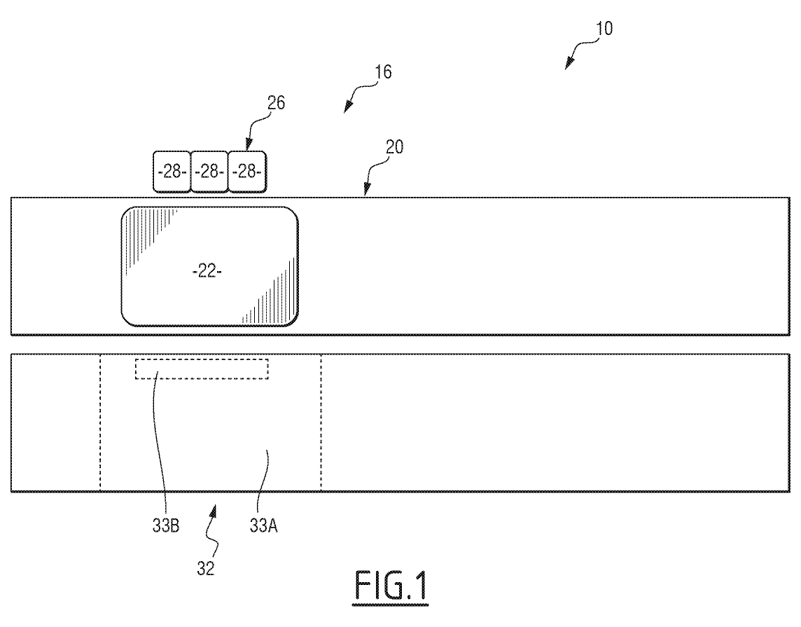

With reference to FIGS. 1 to 5, a vehicle dashboard 10 according to the invention is described.

The vehicle is, for example, a land vehicle, especially a car. However, the invention is not limited to a land vehicle. Thus, in a variant, the vehicle is an air, sea or other vehicle.

The dashboard 10 comprises a dashboard body 12 and a display system 16 according to the invention.

The display system 16 is mounted on the body 12 of the dashboard 10, for example.

In particular, the display system 16 is mounted on a portion of the body 12 of the dashboard 10 intended to be arranged substantially within the field of vision of a driver of the vehicle.

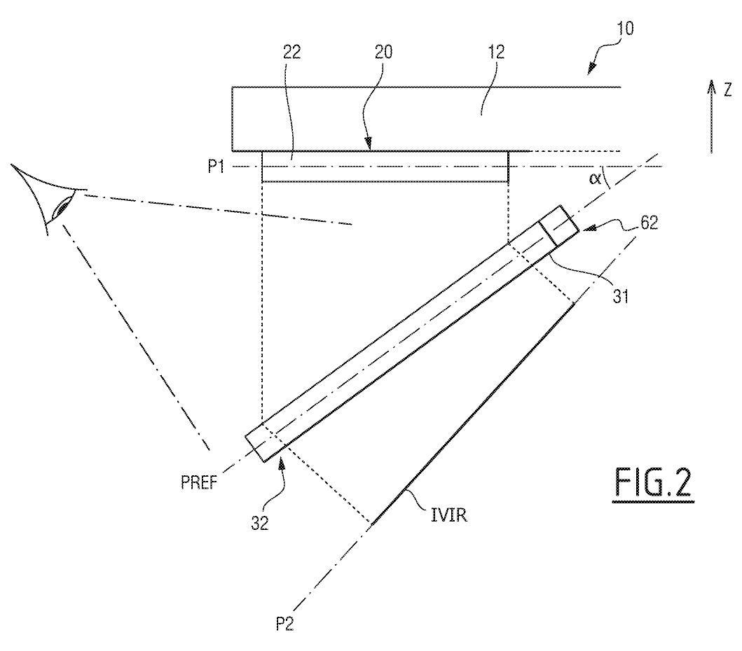

Referring to FIGS. 1 and 2, the display system 16 comprises a display device 20 and a reflective device 32.

In FIG. 1, the display device 20 and the reflective device 32 are illustrated schematically in the plane of the sheet for ease of understanding. The actual arrangement of display device 20 and reflective device 32 is described below.

The display device 20 comprises at least one display screen 22.

Optionally, the display device 20 also comprises at least one head-up display 26.

A single display 22 and, if applicable, a single head-up display 26 are described below. Of course, when the display device 20 comprises a plurality of display screens and/or, if applicable, a plurality of head-up displays, this description applies to one or more display screen(s) of this plurality of display screens and, if applicable, to one or more head-up display(s) of this plurality of head-up displays.

The display screen 22 is intended to be concealed from the passengers of said vehicle.

For example, as depicted in FIG. 2, the display screen 22 is attached to the body 12 of the dashboard 10 and extends in a plane that is, for example, substantially horizontal, especially substantially parallel to the vehicle floor.

Advantageously, the display screen 22 is arranged substantially above the reflective device 32, along a direction of elevation Z substantially orthogonal to the vehicle floor.

Display screen 22 is configured to display real images in a first plane P1. The first plane P1, for example, is substantially parallel to the vehicle floor.

Advantageously, the display screen 22 is configured to display real images representative of information corresponding to a driving assistance system, such as, for example, navigation via GPS (Global Positioning System) and/or an ADAS (Advanced Driver Assistance System) type driving aid.

For example, the information corresponding to a GPS navigation aid includes information relating to at least one item taken from the following list:

navigation information such as real-time map, route and directions, remaining distance, estimated time to destination, street names and exits and/or route recalculation;

traffic information such as traffic conditions, accidents and roadworks and/or proposed alternative routes;

alerts and traffic regulations such as speed limits, danger zones and speed cameras and/or school zones and crosswalks;

points of interest such as gas stations, restaurants, hotels, parking lots and/or electric vehicle charging stations;

additional data such as altitude and GPS coordinates, weather conditions and/or night/day mode.

For example, the information corresponding to an ADAS navigation aid comprises information relating to at least one item taken from the following list:

detection and monitoring aids such as blind spot detection, traffic sign recognition, driver attention monitoring, parking assistance and/or 360° camera;

driving and road-holding aids such as adaptive cruise control, lane-keeping assistance, lane departure warning and/or lane-change assistance;

collision anticipation and avoidance aids such as automatic emergency braking, pedestrian and cyclist detection, forward collision warning and/or rear cross-traffic detection;

specific aids for certain driving conditions, such as downhill assistance, hill-start assistance and/or autonomous or semi-autonomous driving mode.

Even more advantageously, display screen 22 is configured to display real images representative of all the information conventionally provided on a dashboard (for example, speed, fuel gauge, range and/or rev counter), in the form of still images, animations and/or videos, especially in manual driving mode, in autonomous driving mode and/or when the vehicle is stationary. By “manual driving mode”, it is understood that driving is not automated.

The display screen 22 is, for example, an LCD (Liquid Crystal Display), LED (Light-Emitting Diode), OLED (Organic Light-Emitting Diode) or plasma screen.

The head-up display 26 comprises at least one projection source 28 and optical elements (not illustrated).

The at least one projection source 28 comprises a projector or screen.

The optical elements of the head-up display 26 include lenses, reflective mirrors and a reflective surface arranged on a vehicle windscreen or on a dedicated blade.

The head-up display 26 is configured, for example, to display images representative of information relating to at least one item taken from the following list:

vehicle speed;

engine rpm;

fuel level;

engine temperature;

total and partial mileage;

gear lever position;

remaining autonomy;

fuel consumption; and

driving mode.

Alternatively, and especially in a variant wherein the display device 20 does not include the head-up display 26, the display screen 22 is further configured to display actual images representative of information relating to at least one item taken from the following list:

vehicle speed;

engine rpm;

fuel level;

engine temperature;

total and partial mileage;

gear lever position;

remaining autonomy;

fuel consumption; and

driving mode.

The reflective device 32 extends along a plane of reflection PREF.

As depicted in FIG. 2, the plane of reflection PREF forms for example an acute angle α with the first plane P1.

The reflective device 32 is especially intended to be arranged substantially within the field of vision of a vehicle driver.

Referring to FIGS. 2 to 4, the reflective device 32 comprises at least one semi-reflective blade 35, at least one translucent film 40 and at least one lighting unit 62.

Advantageously, the reflective device 32 further comprises at least one rear anti-reflective film 50.

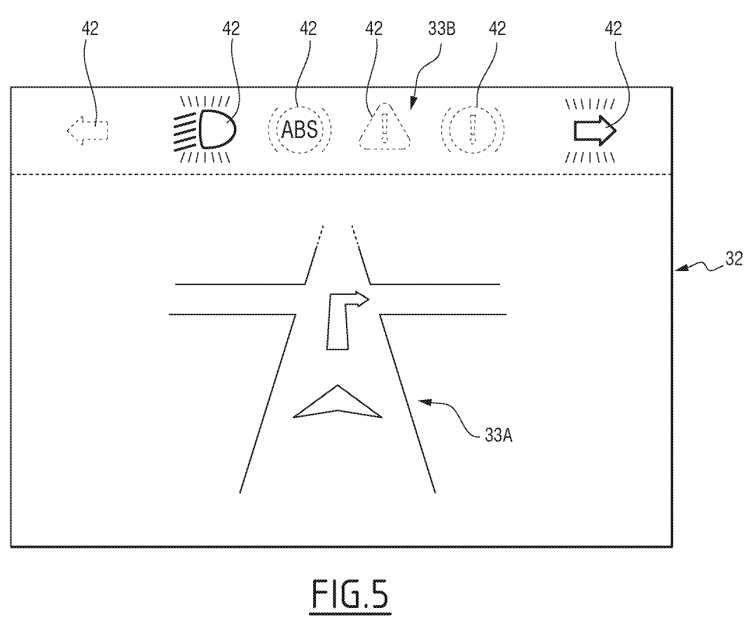

Even more advantageously, as depicted in FIGS. 1 and 5, the reflective device 32 delimits in the plane of reflection PREF:

a reflection surface 33A intended to reflect real images displayed by the display screen 22; and

an information surface 33B intended to illuminate information elements 42 of the at least one translucent film 40 of the reflective device 32.

Even more advantageously, the reflection surface 33A and the information surface 33B are separate and adjacent in the plane of reflection PREF.

In particular, as depicted in the example in FIG. 5, the information surface 33B is above the reflection surface 33A. In a variant not depicted, the information surface 33B is below the reflection surface 33A.

A reflective device 32 comprising a single semi-reflective sheet 35, a single translucent film 40, a single lighting unit 62 and optionally a single rear anti-reflective film 50 is described below. Of course, the invention is not limited to this particular number of blades or films, and also relates to a reflective device comprising a plurality of semi-reflective blades, a plurality of translucent films, a plurality of lighting units and, if required, a plurality of rear anti-reflective films.

Advantageously, the semi-reflective blade 35 comprises a substrate 36 and, for example, a semi-reflective treatment 56.

The semi-reflective blade 35 extends along the plane of reflection PREF.

For example, the semi-reflective blade 35 has a reflectivity of between 30% and 40%.

Advantageously, the semi-reflective blade 35 is made of glass and/or optical-grade plastic, for example acrylic methyl methacrylate (PMMA), polycarbonate (PC), or a mixture of PMMA and PC.

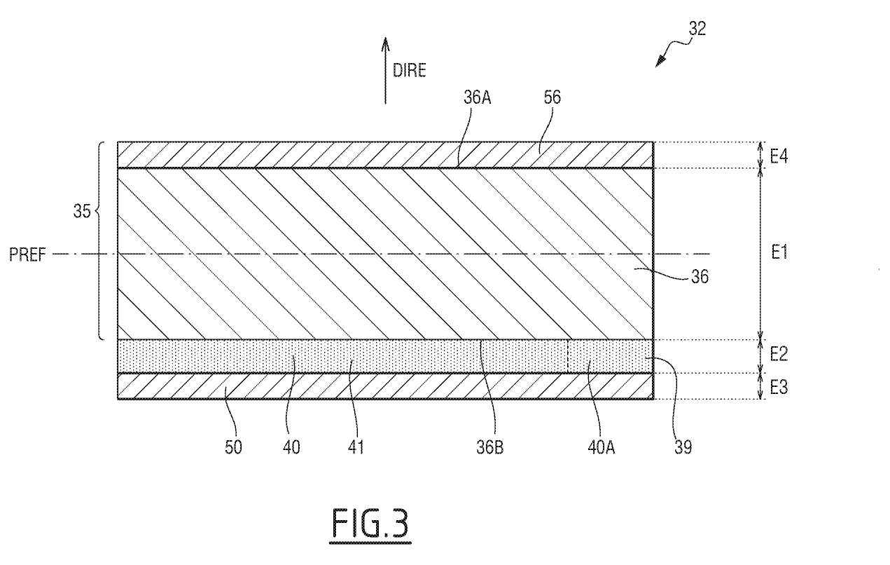

Referring to FIGS. 2 and 3, the semi-reflective blade 35 is intended to reflect real images displayed by the display screen 22 towards the passengers to generate corresponding virtual images IVIR in a second plane P2.

For example, the substrate 36 comprises a front face 36A and a rear face 36B.

The front face 36A faces substantially towards the display screen 22.

The rear face 36B is opposite the front face 36A.

With reference to FIG. 3, advantageously, the substrate 36 has a thickness E1 measured along a thickness direction DIRE substantially orthogonal to the plane of reflection PREF, of between 2 mm and 5 mm.

The translucent film 40 is applied to the semi-reflective blade 35, in particular to the rear face 36B of the substrate 36.

The translucent film 40 is especially applied to the semi-reflective blade 35, in particular to the rear face 36B of the substrate 36.

The translucent film 40 runs parallel to the plane of reflection PREF.

Advantageously, the translucent film 40 extends between the semi-reflective blade 35 and the rear anti-reflective film 50.

The translucent film 40 has a thickness E2 measured along the thickness direction DIRE, especially between 50 µm and 200 µm.

For example, the translucent film 40 has a transparency coefficient greater than or equal to 90%.

The translucent film 40 comprises at least one information element 42, advantageously a plurality of information elements 42.

Advantageously, the translucent film 40 comprises a body 41 whereupon the information elements 42 are printed and/or engraved, in particular micro-printed and/or micro-engraved or nano-printed and/or nano-engraved. In particular, the printings/engravings are designed not to be visible to the naked eye and to collimate the light emitted at the output.

Advantageously, each information element 42 is a pictogram, especially a safety and/or regulatory pictogram.

The pictogram can be selected from a list including:

an indicator for the use of lights, such as position lights, low-beam headlights, high-beam headlights, front and/or rear fog lights, turn signals and/or hazard warning lights;

a malfunction indicator such as, for example an indicator for low oil level, worn front brake pads, ABS (Antilock Braking System) malfunction, power steering malfunction, airbag malfunction, ESP (Electronic Stability Program) malfunction, bulb problem, low windshield washer fluid level, electronic component fault, engine pollution control problem, water in the fuel filter and/or low fuel level;

a hazard indicator such as, for example an indicator for handbrake applied, brake failure, airbag failure, trunk door open, low battery, abnormal engine oil pressure, engine oil overheating, abnormal coolant temperature, abnormal tire pressure, steering lock malfunction and/or seatbelt not fastened.

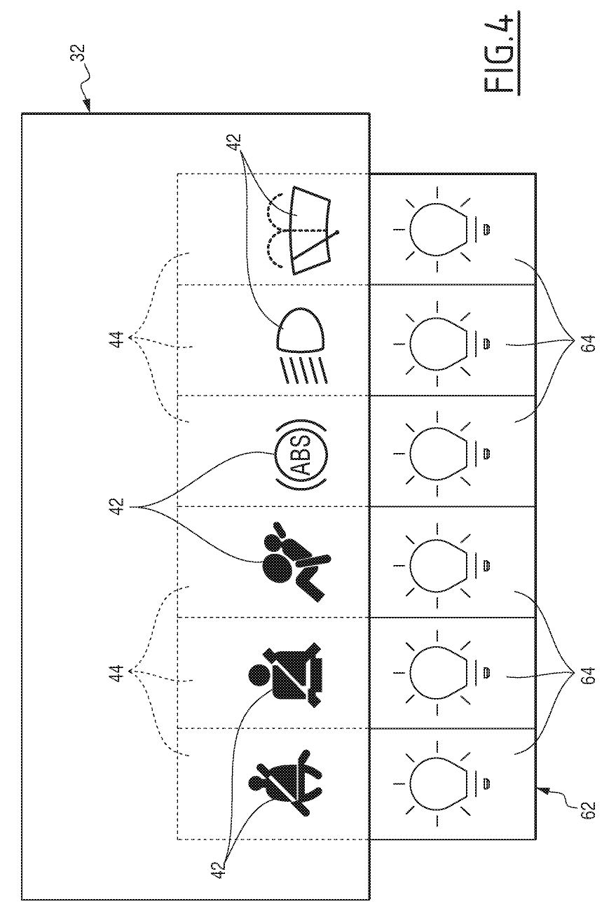

In the example depicted in FIG. 4, the translucent film 40 comprises six information elements 42, including two seatbelt not fastened pictograms, an airbag failure pictogram, an ABS malfunction pictogram, a low-beam usage pictogram and a low washer fluid level pictogram.

In the example depicted in FIG. 5, the translucent film 40 comprises six information elements 42, including a left turn signal pictogram, a low-beam pictogram, an ABS malfunction pictogram, an electronic component fault pictogram, a handbrake applied pictogram and a right turn signal pictogram.

Even more advantageously, the translucent film 40 comprises an information portion 40A wherein the information elements 42 are arranged.

Even more advantageously, the translucent film 40, in particular the information portion 40A of the translucent film 40, comprises a plurality of information zones 44.

Each information zone 44 comprises an information element 42.

The information zones 44 are compartmentalized, especially so that light emitted in one information zone 44 does not penetrate the adjacent information zone(s) 44. In particular, the information zones 44 are compartmentalized by sufficiently spacing them from one another.

In one particular example, several information elements 42 are superimposed in the thickness of the translucent film 40.

The rear anti-reflective film 50 extends over the whole of the translucent film 40.

For example, the rear anti-reflective film 50 has a surface covered with nanometric patterns. These nanometric patterns scatter and absorb light, reducing reflections.

For example, the rear anti-reflective film 50 is an anti-reflective film imitating the fine, irregular structure of moth eyes, known especially under the trade designation MOSMITE^{TM}.

Advantageously, the rear anti-reflective film 50 has a thickness E3 measured along the thickness direction DIRE, especially between 50 µm and 400 µm.

The semi-reflective treatment 56 extends over at least part of the front face 36A of the substrate 36 so as to be arranged opposite the at least one information portion 40A. According to a variant not depicted, the semi-reflective treatment 56 extends over at least part of the rear face 36B of the substrate 36 so as to be arranged opposite the at least one information portion 40A.

For example, the semi-reflective treatment 56 is a coating.

Advantageously, the semi-reflective treatment 56 has a thickness E4 measured along the thickness direction DIRE, especially between 10 µm and 400 µm.

Referring to FIGS. 2 and 4, the lighting unit 62 is capable of illuminating the information elements 42.

The lighting unit 62 comprises a light source 64 for each information element 42.

As depicted in FIG. 2, each light source 64 is arranged along an edge 31 of the reflective device 32 in the plane of reflection PREF, in particular along an edge 39 of the translucent film 40.

Each light source 64 is configured to illuminate the corresponding information element 42 through the thickness of the translucent film 40.

In particular, as depicted in the example in FIG. 4, each light source 64 is arranged opposite an information zone 44 and is configured to illuminate only the information zone 44 opposite which it is arranged.

For example, each light source 64 is a light-emitting diode (LED).

Advantageously, the field of projection and dissipation of the light emitted by each light source 64 allows light to be introduced optimally into the translucent film 40 and is generally comprised within a cone of 10°.

In the example depicted in FIG. 5:

the reflection surface 33A reflects the actual images displayed by the display screen 22, which in this case are representative of information corresponding to a GPS navigation aid;

certain information elements 42 are illuminated through the information surface 33B, in particular a low-beam usage indicator and right turn signal usage indicator, the other information elements 42 being unlit and invisible to passengers.

By virtue of the invention, the virtual images IVIR are displayed in depth in relation to the information elements 42. This makes it easier to highlight the information elements 42 in relation to the images generated by the display screen 22. This also enhances the aesthetics of the display, giving passengers the impression of a 3D view.

In addition, the present solution allows pictograms to be displayed with greater lighting intensity, especially in comparison with the lighting intensity reflected by the reflective device.

In addition, the invention reduces the size of the display system 16. Indeed, by arranging the lighting unit 62 along an edge 39 of the translucent film 40 and illuminating the information elements 42 through the thickness of the translucent film 40, the thickness of the reflective device 32 can be significantly reduced.

1. A display system for a vehicle, comprising:
a display device comprising at least one display screen intended to be concealed from the passengers of said vehicle and being configured to display real images in a first plane;
a reflective device extending along a plane of reflection and comprising:
at least one semi-reflective blade extending along a plane of reflection and intended to reflect real images displayed by the at least one display screen towards the passengers to generate corresponding virtual images in a second plane;
at least one translucent film applied to the at least one semi-reflective blade and comprising at least one information element, the at least one translucent film extending parallel to the plane of reflection and having a thickness in a direction substantially perpendicular to the plane of reflection;
at least one lighting unit capable of illuminating the at least one information element;
characterized in that the at least one lighting unit comprises a light source for each information element, each light source being arranged along an edge of the translucent film and being configured to illuminate the corresponding information element through the thickness of the translucent film.

2. The display system according to claim 1, wherein the at least one semi-reflective blade comprises a substrate having a front face oriented substantially towards the at least one display screen and a rear face opposite the front face, the at least one translucent film being applied to the rear face of the substrate.

3. The display system according to claim 2, wherein the reflective device comprises at least one rear anti-reflective film extending over the whole of the at least one translucent film, so that the at least one translucent film extends between the semi-reflective blade and the rear anti-reflective film.

4. The display system according to claim 2, wherein the at least one translucent film comprises an information portion wherein the information elements are arranged, the semi-reflective blade comprising at least one semi-reflective treatment extending over at least part of the front face of the substrate so as to be arranged opposite at least the at least one information portion.

5. The display system according to claim 1, wherein the at least one information element is a pictogram.

6. The display system according to claim 5, wherein the pictogram is selected from a list comprising:
an indicator for the use of lights;
a malfunction indicator;
a hazard indicator.

7. The display system according to claim 6, wherein the indicator for the use of lights is an indicator for the use of position lights, low-beam headlights, high-beam headlights, front and/or rear fog lights, turn signals and/or hazard warning lights.

8. The display system according to claim 6, wherein the malfunction indicator is an indicator for low oil level, worn front brake pads, ABS malfunction, power steering malfunction, airbag malfunction, ESP malfunction, bulb problem, low windshield washer fluid level, electronic component fault, engine pollution control problem, water in the fuel filter and/or low fuel level.

9. The display system according to claim 6, wherein the hazard indicator is an indicator for handbrake applied, brake failure, airbag failure, trunk door open, low battery, abnormal engine oil pressure, engine oil overheating, abnormal coolant temperature, abnormal tire pressure, steering lock malfunction and/or seatbelt not fastened.

10. The display system according to claim 1, wherein the at least one information element is printed and/or engraved on a body of the at least one translucent film.

11. The display system according to claim 10, wherein the at least one information element is micro-printed and/or micro-engraved or nano-printed and/or nano-engraved on the body of the at least one translucent film.

12. The display system according to claim 1, wherein the at least one translucent film comprises a plurality of information zones, each information zone comprising an information element, the information zones being compartmentalized, each light source being arranged opposite an information zone and being configured to illuminate only the information zone opposite to which it is arranged.

13. The display system according to claim 1, wherein the reflective device delimits in the plane of reflection:
a reflection surface intended to reflect real images displayed by the at least one display screen; and
an information surface intended to illuminate the information elements;
the reflection surface and information surface being separate and adjacent.

14. A vehicle dashboard comprising a body and a display system according to claim 1, the display system being mounted on the body of the dashboard.
